(19) United States
(12) Patent Application Publication
(10) Pub. No.: US 2026/0261079 A1
(43) Pub. Date: Sep. 3, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Pengfei LANG, Mie (JP)

(21) Appl. No.: 18/878,657

(22) PCT Filed: Jun. 15, 2023
(86) PCT No.: PCT/JP2023/022212

§ 371 Date: Dec. 24, 2024

(30) Foreign Application Priority Data
Jun. 30, 2022 (JP) 2022-105999

(51) Int. Cl. H01R 13/629; H01R 13/506

(52) U.S. Cl. CPC H01R 13/62944; H01R 13/506; H01R 13/62922; H01R 13/6295

(57) ABSTRACT

A connector (10) includes a housing (20) to be connected to a mating housing (110), a lever (30) to be assembled with the housing (20) rotatably between a rotation start position and a rotation end position and configured to connect the housing (20) to the mating housing (110) by rotating from the rotation start position to the rotation end position, and a detecting portion (70) for detecting whether or not the lever (30) is at the rotation start position in assembling the lever (30) with the housing (20).

### TECHNICAL FIELD

The present disclosure relates to a connector.

### BACKGROUND

A lever-type connector disclosed in Patent Document 1 is provided with a first housing and a second housing to be connected to each other, a lever to be mounted on the first housing and rotatable between an initial position and a connection position and a slider to be mounted on the first housing and parallelly movable between a connection start position and a connection end position. The slider is provided with a cam groove for allowing the entrance of a cam follower formed on the second housing at the connection start position and causing the cam follower to slide in contact therewith in the process of moving from the connection start position to the connection end position. The second housing is pulled toward and connected to the first housing by moving the slider from the connection start position to the connection end position and causing the cam follower to slide in contact with the cam groove by rotating the lever from the initial position to the connection position.

### PRIOR ART DOCUMENT

### Patent Document

Patent Document 1: JP 2018-195400 A

### SUMMARY OF THE INVENTION

### Problems to be Solved

In a configuration provided with a lever and a follower member configured to follow the lever as in Patent Document 1, a case is assumed in which the relative rotation position of the lever with respect to the follower member is not a proper position (initial position) in assembling the lever with the follower member. In such a case, even if the lever is rotated from the initial position to a connection position after the lever is assembled with the follower member, it may not be possible to move the follower member to a connection end position. In this case, both housings are left in an incompletely connected state.

A connector of the present disclosure was completed on the basis of the above situation and aims to be able to detect whether or not a lever is at a rotation start position in assembling the lever with a housing.

### Means to Solve the Problem

The present disclosure is directed to a connector with a housing to be connected to a mating housing, a lever to be assembled with the housing rotatably between a rotation start position and a rotation end position, the lever connecting the housing to the mating housing by rotating from the rotation start position to the rotation end position, and a detecting portion for detecting whether or not the lever is at the rotation start position in assembling the lever with the housing.

### Effect of the Invention

According to the present disclosure, whether or not a lever is at a rotation start position can be detected in assembling the lever with a housing.

### BRIEF DESCRIPTION OF THE DRAWINGS

FIG. 1 is a perspective view of a connector according to one embodiment.

FIG. 2 is a perspective view showing a disassembled state of the connector.

FIG. 3 is a side view showing a state where a lever assembled with a wire cover is at a rotation start position.

FIG. 4 is a side view showing a state when the lever at the rotation start position is assembled with a housing body.

FIG. 5 is a side view in section of the housing body.

FIG. 6 is a side view in section showing a state before the connector and a mating connector are connected with a slider located at the connection start position.

FIG. 7 is an enlarged plan view in section along A-A of FIG. 6 showing a holding state and a holding released state by a holding portion.

FIG. 8 is a side view in section showing a state where the connector and the mating connector are connected.

FIG. 9 is a side view showing a state where the lever assembled with the wire cover is at a position shifted from the rotation start position.

FIG. 10 is a side view showing a state when the lever at the position shifted from the rotation start position is assembled with the housing body.

FIG. 11 is a diagram showing a force applied to a pin when the lever at the position shifted from the rotation start position is assembled with the housing body.

### DETAILED DESCRIPTION TO EXECUTE THE INVENTION

### Description of Embodiments of Present Disclosure

First, embodiments of the present disclosure are listed and described.

[1] The connector of the present disclosure is provided with a housing to be connected to a mating housing, a lever to be assembled with the housing rotatably between a rotation start position and a rotation end position, the lever connecting the housing to the mating housing by rotating from the rotation start position to the rotation end position, and a detecting portion for detecting whether or not the lever is at the rotation start position in assembling the lever with the housing.

According to the configuration of the present disclosure, whether or not the lever is at the rotation start position can be detected by the detecting portion in assembling the lever with the housing.

[2] In the connector of [1], the detecting portion includes a pin provided on the lever and a groove portion provided in the housing, and the groove portion is provided along a movement path of the pin when the lever at the rotation start position is assembled with the housing. According to this configuration, if the lever is at the rotation start position when being assembled with the housing, the pin enters the groove portion, whereby it can be detected that the lever is at the rotation start position.

[3] In the connector of [2], the groove portion includes an arcuate part curved along the movement path of the pin according to rotation of the lever. According to this configuration, since a cut part can have a minimum necessary size as compared to a configuration in which a wide region including the movement path of the pin is largely cut, the strength of the housing is easily ensured.

[4] In the connector of [3], the lever is invertible about a virtual axis passing through an axis of rotation of the lever and parallel to a connection direction of the housing and the mating housing and assemblable with the housing when viewed from an axial direction parallel to the axis of rotation, and the pin moves through the virtual axis according to a movement of the lever between the rotation start position and the rotation end position when viewed from the axial direction. According to this configuration, the lever can be inverted about the virtual axis and assembled with the housing. Moreover, since the pin moves through the virtual axis when viewed from the axial direction, the groove portion can be configured to hardly expand in a direction separating from the axis of rotation.

[5] In the connector of any one of [1] to [4], a slider is provided which connects the housing and the mating housing by relatively moving from a connection start position to a connection end position with respect to the housing according to rotation of the lever from the rotation start position to the rotation end position, and the slider includes a holding portion for holding the slider at the connection start position. According to this configuration, the slider can be held at the connection start position by the holding portion, whereby the lever can be held at the rotation start position. Thus, cumbersome operations such as unlocking become unnecessary as compared to a configuration in which a locking mechanism is provided between the lever and the housing.

### Details of Embodiment of Present Disclosure

### Embodiment

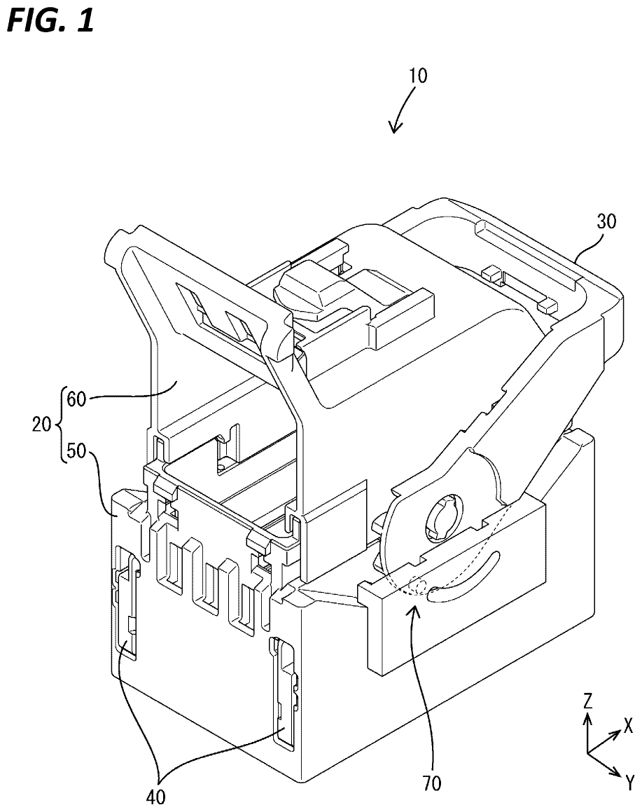

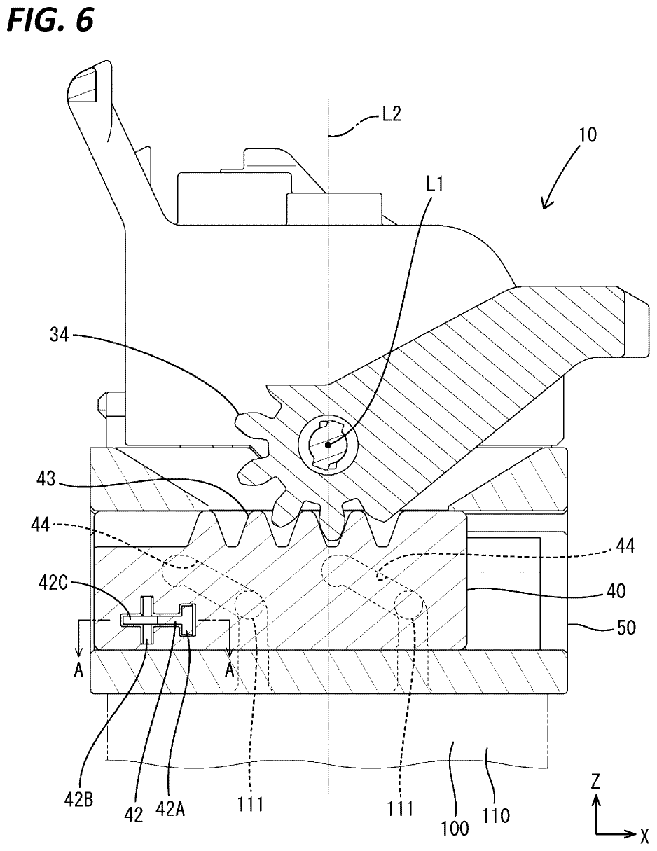

A connector of a specific embodiment of the present disclosure is described below with reference to FIGS. 1 to 11. The present invention is not limited to these illustrations, but is represented by claims and intended to include all changes in the scope of claims and in the meaning and scope of equivalents. In this embodiment, a positive direction of an X axis in FIGS. 1 and 6 is defined as a forward direction concerning a front-rear direction. A positive direction of a Y axis in FIG. 1 is defined as a rightward direction concerning a lateral direction. The lateral direction and a width direction are used as synonyms. A positive direction of a Z axis in FIGS. 1 and 6 is defined as an upward direction concerning a vertical direction.

### 1. Configuration of Connector

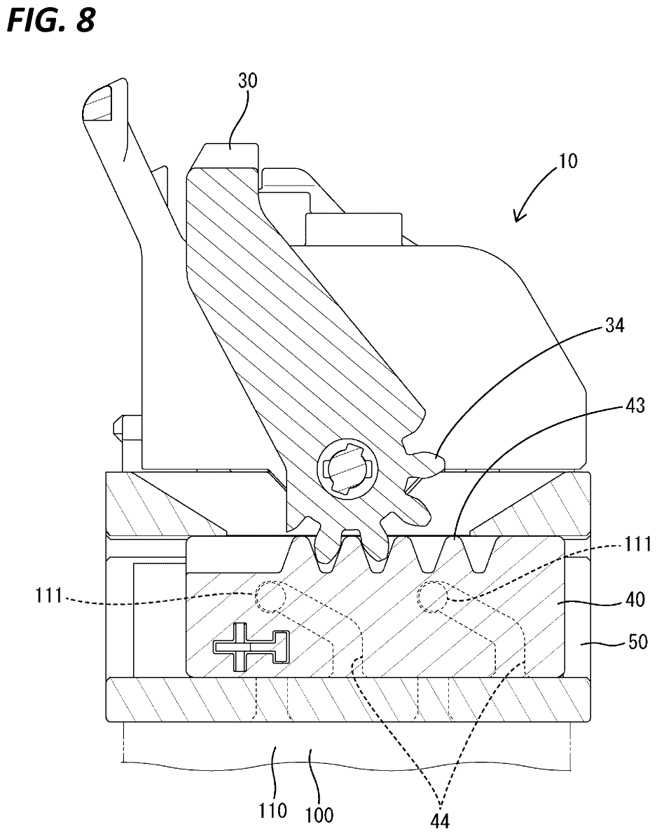

A connector 10 of this embodiment is, as shown in FIG. 1, provided with a housing 20, a lever 30 and a pair of sliders 40. As shown in FIG. 8, the connector 10 is connected to a mating connector 100. The mating connector 100 is provided with a mating housing 110.

The housing 20 includes a housing body 50 and a wire cover 60. The housing body 50 and the wire cover 60 are, for example, made of synthetic resin. Female terminal fittings (not shown) are, for example, inserted into the housing body 50. Wires (not shown) connected to the terminal fittings are drawn out upward from the housing body 50, bent in the wire cover 60 and drawn out rearward from the housing 20. The lever 30 is rotatably assembled with the wire cover 60.

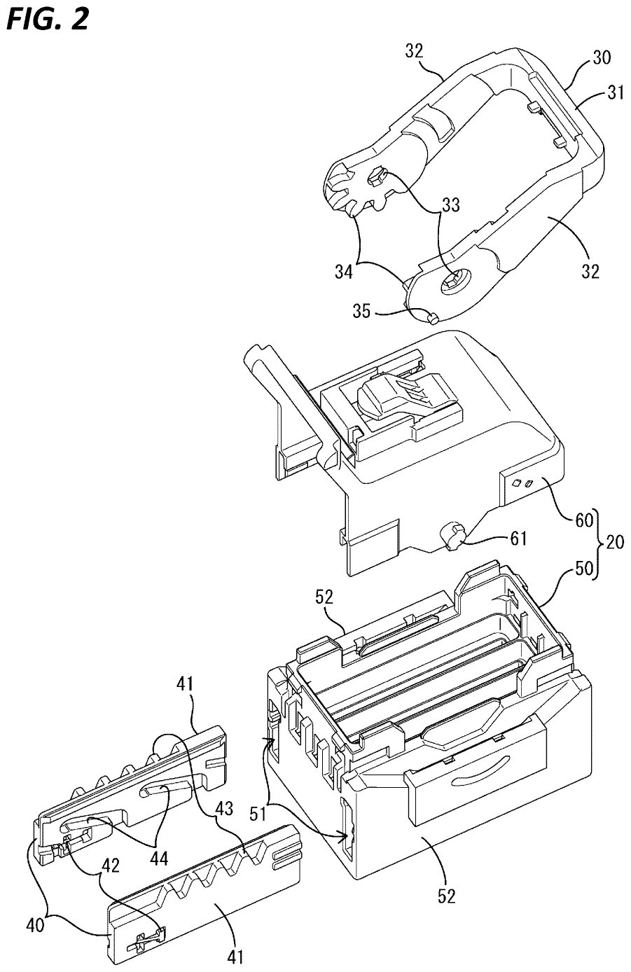

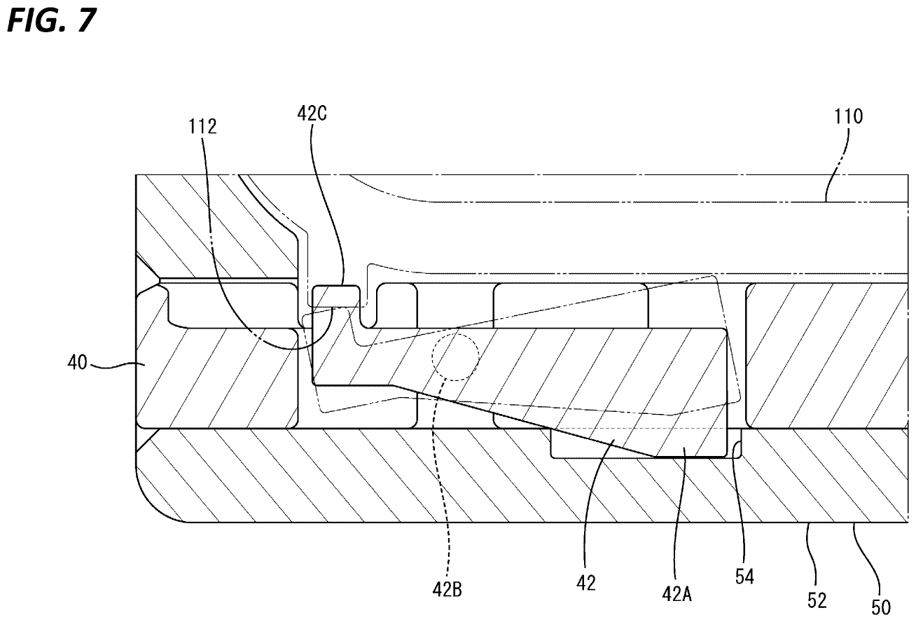

The housing body 50 is configured to be symmetrical in the front-rear direction. As shown in FIG. 2, a pair of left and right guide spaces 51 extending in the front-rear direction are formed in the housing body 50. The slider 40 is accommodated into the guide space 51. The pair of guide spaces 51 are located along both left and right outer wall portions 52 of the housing body 50. Both front and rear ends of the guide space 51 are open in the form of slits elongated in the vertical direction in both front and rear end surfaces of the housing body 50. As shown in FIG. 7, stoppers 54 are formed by recessing the inner surface (surface facing the guide space 51) of the outer wall portion 52 in both front and rear end parts of the guide space 51. The stopper 54 contacts the slider 40 to hold the slider 40 as described later.

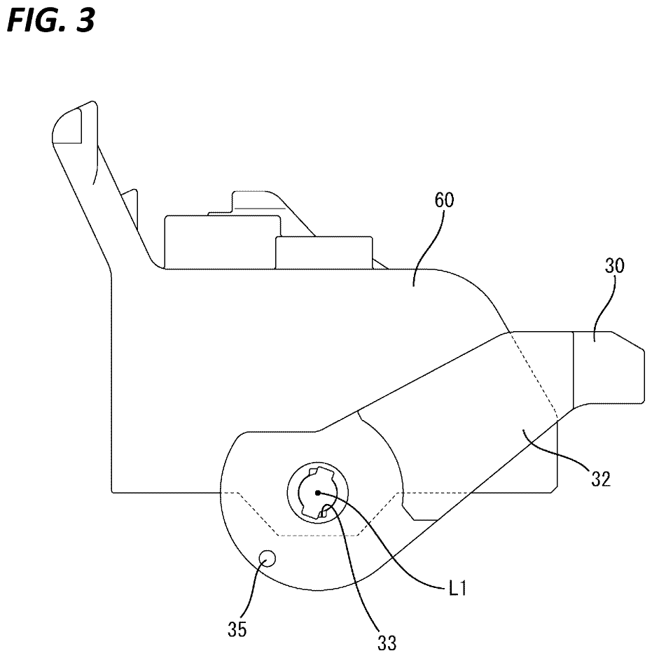

The lever 30 includes an operating portion 31 and a pair of bilaterally symmetrical arm portions 32. The operating portion 31 has a shape elongated in the lateral direction. The pair of arm portions 32 extend from both left and right ends of the operating portion 31. The lever 30 is, for example, a single component made of synthetic resin. The arm portion 32 is provided with a bearing hole 33. The bearing hole 33 is fit to a shaft portion 61 of the wire cover 60. If the operating portion 31 is gripped and an operation force is applied to the lever 30, the lever 30 rotates between a rotation start position (see FIGS. 3 and 6) and a rotation end position (see FIG. 8) about the shaft portions 61 of the wire cover 60. The operating portion 31 is located in front of the shaft portions 61 at the rotation start position, and located behind the shaft portions 61 at the rotation end position. An arcuate gear 34 concentric with the bearing hole 33 is formed on the inner surface of the arm portion 32. The gear 34 is meshed with a rack 43 of the housing body 50 to be described later.

The slider 40 parallelly moves in the front-rear direction between a connection start position and a connection end position where the both housings 20, 110 are connected as the lever 30 is operated. The slider 40 is, for example, made of synthetic resin. The slider 40 includes a plate-like body portion 41 and a holding portion 42. The slider 40 is a single component. As shown in FIG. 2, the plate-like body portion 41 is in the form of a rectangular plate long in the front-rear direction. The rack 43 extending in the front-rear direction is formed on an upper edge part of the plate-like body portion 41. As shown in FIGS. 2 and 6, a pair of cam grooves 44 separated in the front-rear direction are provided in the inner side surface (surface facing the other plate-like body portion 41) of the plate-like body portion 41. The lower ends of the cam grooves 44 are open downward.

As shown in FIGS. 2 and 6, the holding portion 42 is provided on a rear end side of the plate-like body portion 41. The holding portion 42 functions to hold the slider 40 at the connection start position. As shown in FIGS. 6 and 7, the holding portion 42 includes an arm-like locking piece 42A, a supporting portion 42B and a releasing extending portion 42C. The arm-like locking piece 42A is elongated in the front-rear direction. The supporting portion 42B extends in the vertical direction from the base end of the arm-like locking piece 42A. The extending ends of the supporting portion 42B are connected to the plate-like body portion 41 and supported on the plate-like body portion 41. The releasing extending portion 42C is cantilevered from the base end of the arm-like locking piece 42A toward a side opposite to the arm-like locking piece 42A. The holding portion 42 is tiltable in the lateral direction with the supporting portion 42B as a fulcrum.

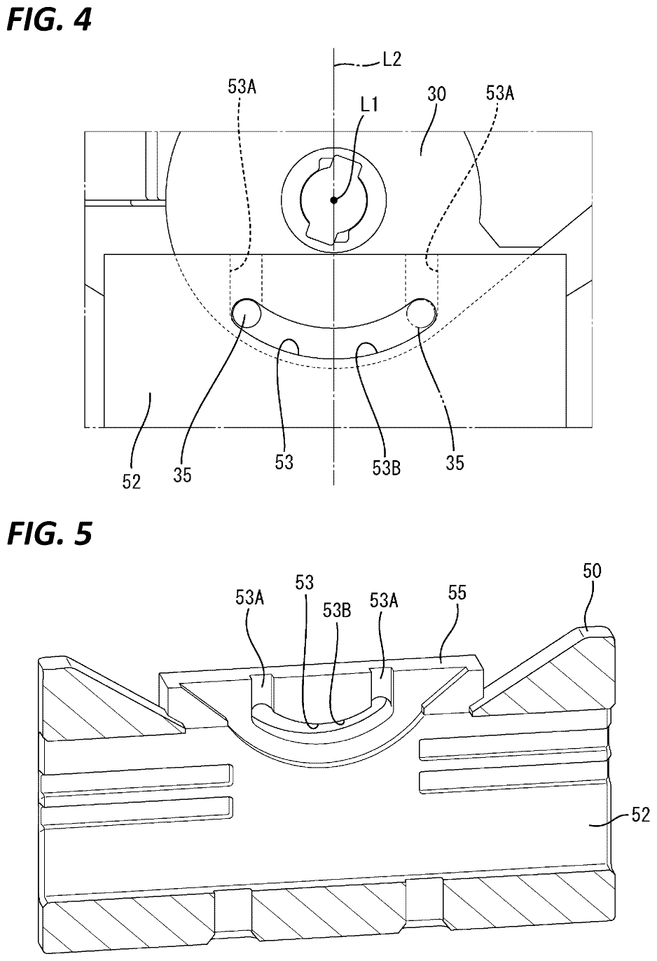

As shown in FIG. 4, the connector 10 is provided with detecting portions 70. The detecting portion 70 functions to detect whether or not the lever 30 is at the rotation start position in assembling the lever 30 with the housing body 50. The detecting portion 70 includes a pin 35 provided on the lever 30 and a groove portion 53 and the outer wall portion 52 provided in the housing body 50. The detecting portions 70 are provided on both left and right sides of the connector 10.

As shown in FIGS. 2 and 3, the pin 35 has a cylindrical shape and projects in parallel to the shaft portion 61 from a laterally outer surface (surface on a side opposite to the other arm portion 32) of the arm portion 32. The pin 35 is eccentric with respect to an axis of rotation L1 (see FIG. 3) in the lever 30. The pin 35 is located on a side opposite to the operating portion 31 across the bearing hole 33.

The groove portions 53 are formed in the inner surfaces (surfaces facing the guide spaces 51) of the both left and right outer wall portions 52 of the housing body 50. Here, an axis passing through the axis of rotation L1 and parallel to a connection direction (Z-axis direction) of the housing 20 and the mating housing 110 when viewed from an axial direction parallel to the axis of rotation L1 (see FIG. 6) of the lever 30 is assumed as a virtual axis L2. The groove portion 53 is symmetrical in the front-rear direction with respect to the virtual axis L2.

As shown in FIGS. 4 and 5, the groove portion 53 includes a pair of end side parts 53A and a central part 53B provided between the pair of end side parts 53A. The end side part 53A extends in the vertical direction. The end side part 53A is provided along a movement path of the pin 35 when the lever at the rotation start position is assembled with the housing body 50. Both ends of the central part 53B are connected to the lower ends of the both end side parts 53A. The central part 53B is an arcuate part curved along the movement path of the pin 35 according to the rotation of the lever 30. The central part 53B has an arcuate shape convex downward. The central part 53B penetrates through the outer wall portion 52 of the housing body 50 in a wall thickness direction.

### 2. Configuration of Mating Connector

The mating connector 100 is provided with the mating housing 110 (see FIG. 6) and mating terminal fittings (not shown). The mating housing 110 includes cam followers 111 (see FIG. 6) and holding releasing portions 112 (see FIG. 7). A pair of the cam followers 111 are provided on each of both left and right side surfaces of the mating housing 110. The pair of cam followers 111 are disposed at an interval in the front-rear direction on each of the both left and right side surfaces of the mating housing 110. The cam follower 111 is in the form of a cylindrical projection. The holding releasing portions 112 are in the form of projections in both front and rear end parts of the both left and right outer side surfaces of the mating housing 110.

### 3. Assembly Process of Connector

Next, an assembly process of the connector 10 is described. First, the lever 30 is rotatably assembled with the wire cover 60. As shown in FIG. 3, the lever 30 is moved to the rotation start position with respect to the wire cover 60. The sliders 40 are accommodated in the guide spaces 51 of the housing body 50. The sliders 40 are moved to the connection start position. The sliders 40 at the connection start position are restricted from moving toward the connection end position and held at the connection start position by the holding portions 42.

In a state where the both connectors 10, 100 are not connected yet and the sliders 40 are at the connection start position, the holding portion 42 is at a holding position as shown by a solid line in FIG. 7. The arm-like locking piece 42A is located to face the stopper 54 provided in the inner surface of the housing body 50 from behind. If the slider 40 is biased toward the connection end position, the arm-like locking piece 42A butts against the stopper 54, thereby restricting a movement of the slider 40.

Subsequently, the lever 30 and the wire cover 60 are assembled with the housing body 50. At this time, whether or not the lever 30 is at the rotation start position can be detected by the detecting portions 70. Since one (rear) end side part 53A, out of the pair of end side parts 53A of the groove portion 53, is provided along the movement path of the pin 35 when the lever 30 at the rotation start position is assembled with the housing body 50, the pins 35 enter the end side parts 53A as shown by a solid line in FIG. 4 if the lever 30 is locate at the rotation start position as shown in FIG. 3. Thus, it can be detected that the lever 30 is at the rotation start position. If the pins 35 enter the end side parts 53A and the lever 30 and the wire cover 60 are properly assembled with the housing body 50, the gears 34 of the lever 30 and the racks 43 of the housing body 50 are meshed.

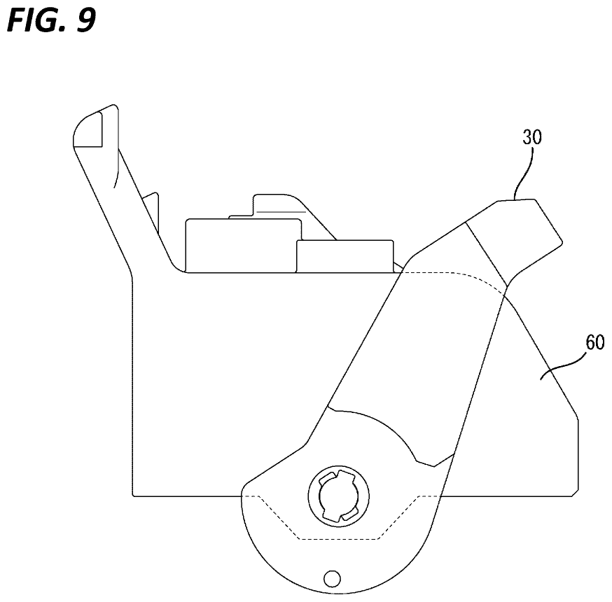

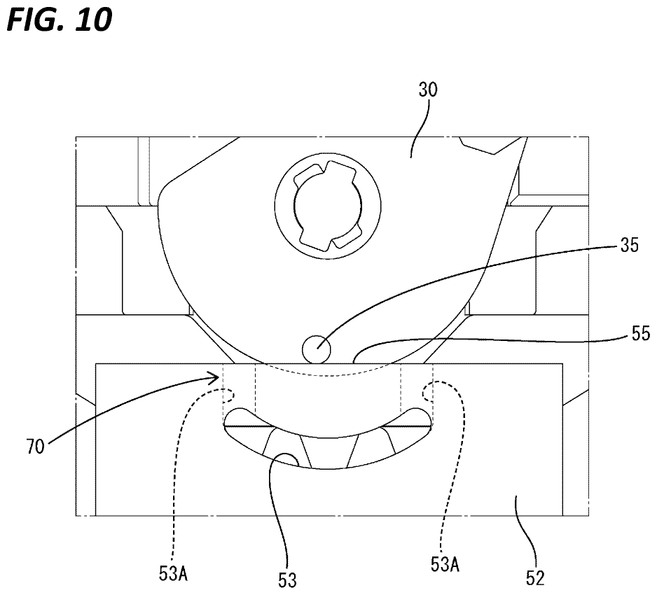

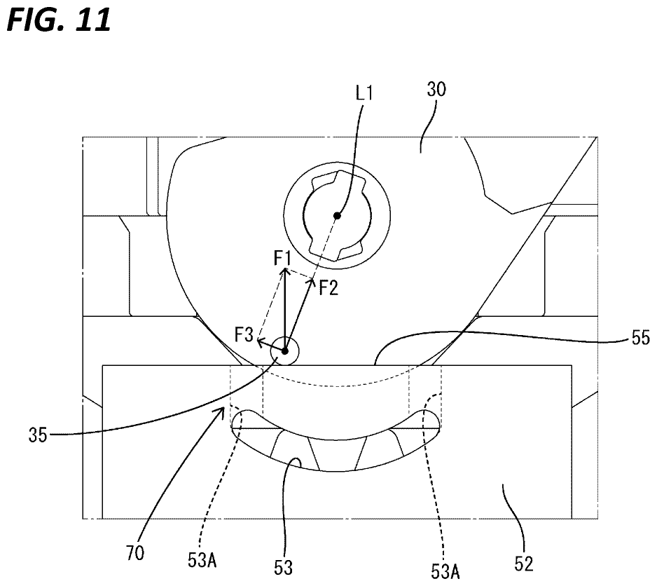

On the other hand, if the lever 30 is at a position shifted from the rotation start position as shown in FIG. 9, the pins 35 interfere with upper end edges 55 (parts where the end side parts 53A are not open) of the outer wall portions 52 of the housing body 50 as shown in FIG. 10. Thus, the pins 35 do not enter the end side parts 53A and it can be detected that the lever 30 is not at the rotation start position.

### 4. Connection Process of Connector and Mating Connector

Next, a connection process of the connector 10 and the mating connector 100 is described. In a state where the lever 30 is at the rotation start position and the sliders 40 are held at the connection start position, the mating housing 110 is fit into the housing body 50 from below. As shown in FIG. 6, the cam followers 111 enter the cam grooves 44. In the process of inserting the mating housing 110, the holding releasing portions 112 press the releasing extending portions 42C as shown in FIG. 7. By this pressing action, the holding portion 42 is tilted toward a holding releasing position (see a two-dot chain line of FIG. 7) with the supporting portion 42B as a fulcrum, and the arm-like locking piece 42A is displaced to a position (position laterally inward of the stopper 54) separated from the stopper 54 as shown in FIG. 7. In this way, the slider 40 is released from a holding state by the housing body 50 and can be moved toward the connection end position.

Thereafter, the operating portion 31 of the lever 30 is gripped and the lever 30 is rotated from the rotation start position to the rotation end position. As the lever 30 is operated, the sliders 40 move from the connection start position to the connection end position and the connector 10 and the mating connector 100 are vertically pulled toward each other by sliding movements of the cam grooves 44 and the cam followers 111. If the lever 30 reaches the rotation end position and the sliders 40 reach the connection end position as shown in FIG. 8, the connection of the connector 10 and the mating connector 100 is completed.

In separating the connector 10 and the mating connector 100 in the connected state, the lever 30 is rotated from the rotation end position to the rotation start position. By this operation, the sliders 40 move from the connection end position to the connection start position and the connector 10 and the mating connector 100 are separated by sliding movements of the cam grooves 44 and the cam followers 111.

### 5. Inverted Assembly of Lever

As described above, the housing body 50 is configured to be symmetrical in the front-rear direction. Thus, the lever 30 can be inverted and assembled with the housing 20 with the aforementioned virtual axis L2 as a center.

When viewed from the axial direction, the pin 35 moves through the virtual axis L2 as the lever 30 moves between the rotation start position and the rotation end position. As shown in FIG. 4, the pin 35 is at a position shown by a solid line when the lever 30 is at the rotation start position, and at a position shown by a one-dot chain line when the lever 30 is at the rotation end position. By this configuration, the movement path of the pin 35 can be disposed to cross over the center (virtual axis L2) in the front-rear direction of the housing body 50. In this way, the groove portion 53 hardly expands in the front-rear direction and can have a minimum necessary size in the front-rear direction.

### 6. Guiding of Lever to Rotation Start Position

If an attempt is made to assemble the lever 30 with the housing body 50 when the lever 30 is located at a position shifted toward the rotation end position from the rotation start position as shown in FIG. 9, the lever 30 may be guided to the rotation start position and rotated. For example, when the pin 35 interferes with the upper end edge 55 of the outer wall portion 52 of the housing body 50 as shown in FIG. 11, the pin 35 receives a force F1 acting upward from the upper end edge 55. If the force F1 is divided into components of directions, a component of the force F1 in a direction toward the axis of rotation L1 is a force F2, and a component in a direction orthogonal to the direction toward the axis of rotation L1 is a force F3. The force F3 is a force for rotating the lever 30 to the rotation start position. Thus, by continuing to push the lever 30 downward, the lever 30 can be guided to the rotation start position and the pin 35 can enter the end side part 53A.

### 7. Effects of Embodiment

The connector 10 of this embodiment is provided with the detecting portions 70 for detecting whether or not the lever 30 is at the rotation start position in assembling the lever 30 and the wire cover 60 with the housing body 50. Thus, in assembling the lever 30 and the wire cover 60 with the housing body 50, whether or not the lever 30 is at the rotation start position can be detected by the detecting portions 70.

The detecting portion 70 of this embodiment includes the pin 35 provided on the lever 30 and the groove portion 53 and the outer wall portion 52 provided in the housing body 50. The end side parts 53A of the groove portion 53 are provided along the movement path of the pin 35 when the lever 30 at the rotation start position is assembled with the housing body 50. According to this configuration, in assembling the lever 30 and the wire cover 60 with the housing body 50, the pin 35 enters the groove portion 53 (end side part 53A) if the lever 30 is at the rotation start position, whereby it can be detected that the lever 30 is at the rotation start position.

The groove portion 53 of this embodiment has the arcuate part (central part 53B) curved along the movement path of the pin 35 according to the rotation of the lever 30. According to this configuration, since a cut part can have a minimum necessary size as compared to a configuration in which a wide region including the movement path of the pin 35 is largely cut, the strength of the housing body 50 is easily ensured.

The lever 30 of this embodiment can be inverted about the virtual axis L2 passing through the axis of rotation L1 of the lever 30 and parallel to the connection direction of the housing 20 and the mating housing 110 when viewed from the axial direction parallel to the axis of rotation L1. When viewed from the axial direction, the pin 35 moves through the virtual axis L2 as the lever 30 moves between the rotation start position and the rotation end position. According to this configuration, the lever 30 can be inverted about the virtual axis L2 and assembled with the housing body 50. Moreover, since the pin 35 moves through the virtual axis L2 when viewed from the axial direction, the groove portion 53 can be configured to hardly expand in a direction separating forward and/or rearward from the virtual axis L2.

The connector 10 of this embodiment is provided with the sliders 40 for connecting the housing 20 and the mating housing 110 by relatively moving from the connection start position to the connection end position with respect to the housing body 50 according to the rotation of the lever 30 from the rotation start position to the rotation end position. The slider 40 includes the holding portion 42 for holding the slider 40 at the connection start position. According to this configuration, the sliders 40 can be held at the connection start position by the holding portions 42, whereby the lever 30 can be held at the rotation start position. Thus, cumbersome operations such as unlocking become unnecessary as compared to a configuration in which a locking mechanism is provided between the lever 30 and the housing 20.

### OTHER EMBODIMENTS

The present invention is not limited to the above described and illustrated embodiment, but is represented by claims. The present invention is intended to include all changes in the scope of claims and in the meaning and scope of equivalents and also include the following embodiments.

Although the housing 20 is composed of the housing body 50 and the wire cover 60 in the above embodiment, a housing as a single component may be used. In this case, the housing is provided with a groove portion and a detecting portion is constituted by a pin of a lever and the groove portion of the housing.

The connector 10 may not be provided with the sliders in the above embodiment. In this case, both housings may be connected by a cam follower provided on one of a lever and a mating housing sliding along a cam groove provided in the other of the lever and the mating housing.

Although the lever is provided with the pins and the housing is provided with the groove portions in the above embodiment, the housing may be provided with the pins and the lever may be provided with the groove portions. The lever rotates relative to the housing by the pins moving in such groove portions.

Although the groove portion 53 includes vertically extending parts (pair of end side parts 53A) in the above embodiment, a groove portion may have an arcuate shape convex downward as a whole without having such parts.

List of Reference Numerals

| | |
|---|---|
| 10 | connector |
| 20 | housing |
| 30 | lever |
| 31 | operating portion |
| 32 | arm portion |
| 33 | bearing hole |
| 34 | gear |
| 35 | pin |
| 40 | slider |
| 41 | plate-like body portion |
| 42 | holding portion |
| 42A | arm-like locking piece |
| 42B | supporting portion |
| 42C | releasing extending portion |
| 43 | rack |
| 44 | cam groove |
| 50 | housing body |
| 51 | guide space |
| 52 | outer wall portion |
| 53 | groove portion |
| 53A | end side part |
| 53B | central part |
| 54 | stopper |
| 55 | upper end edge |
| 60 | wire cover |
| 61 | shaft portion |
| 70 | detecting portion |
| 100 | mating connector |
| 110 | mating housing |
| 111 | cam follower |
| 112 | holding releasing portion |
| L1 | axis of rotation |
| L2 | virtual axis |

1. A connector, comprising:
a housing to be connected to a mating housing;
a lever to be assembled with the housing rotatably between a rotation start position and a rotation end position, the lever connecting the housing to the mating housing by rotating from the rotation start position to the rotation end position; and
a detecting portion for detecting whether or not the lever is at the rotation start position in assembling the lever with the housing.

2. The connector of claim 1, wherein:
the detecting portion includes a pin provided on the lever and a groove portion provided in the housing, and
the groove portion is provided along a movement path of the pin when the lever at the rotation start position is assembled with the housing.

3. The connector of claim 2, wherein the groove portion includes an arcuate part curved along the movement path of the pin according to rotation of the lever.

4. The connector of claim 3, wherein:
the lever is invertible about a virtual axis passing through an axis of rotation of the lever and parallel to a connection direction of the housing and the mating housing and assemblable with the housing when viewed from an axial direction parallel to the axis of rotation, and
the pin moves through the virtual axis according to a movement of the lever between the rotation start position and the rotation end position when viewed from the axial direction.

5. The connector of claim 1, comprising a slider for connecting the housing and the mating housing by relatively moving from a connection start position to a connection end position with respect to the housing according to rotation of the lever from the rotation start position to the rotation end position, wherein:
the slider includes a holding portion for holding the slider at the connection start position.
